(19) United States
(12) Patent Application Publication
(10) Pub. No.: US 2007/0033843 A1
(43) Pub. Date: Feb. 15, 2007

(54) Apparatus and method for indicating a predicted outcome of a match between opposing teams

(76) Inventor: Ronald M. Ford, Manhattan, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/201,622

(22) Filed: Aug. 11, 2005

(51) Int. Cl. G09F 7/04

(52) U.S. Cl. 40/600

(57) ABSTRACT

A display apparatus is provided for indicating the outcome of a match between two rival parties using an article bearing indicia of a sports object that is associated with the particular sport that the rival parties are competing in. A display apparatus is provided featuring an article bearing indicia of a sports object, a first icon attached to the article, a second icon attached to the article and spaced from the first icon, and an outcome indicator attached to the article and positioned substantially intermediate to the first and second icons.

### CROSS REFERENCE TO RELATED APPLICATIONS

None.

### STATEMENT REGARDING FEDERALLY SPONSORED RESEARCH AND DEVELOPMENT

None.

### BACKGROUND OF THE INVENTION

The present invention relates generally to a display apparatus and method. More particularly, the present invention relates to a display apparatus and method for indicating a predicted outcome of a competitive event between two opposing teams.

As long as there have been teams participating in sporting events, there have been sports fans and enthusiasts. Sports fans have shown their team affiliation in a variety of ways including displaying: logo-bearing flags, bumper stickers, banners, apparel, license plate frames, and the like at sports events, in the home, in the car, or various other locations. Successful licensing programs by schools and sports teams at both the amateur and professional levels have increased the variety and popularity of such merchandise. However, while such merchandise convey the affiliation of a sports enthusiast to others, they serve little other purpose.

### BRIEF SUMMARY OF THE INVENTION

There is, therefore, provided in the practice of the invention, a display apparatus and method for indicating the outcome of a match between opposing teams. The inventive apparatus features an article bearing indicia associated with a sports object, an outcome indicator, and first and second icons representing opposing teams. A display apparatus comprising an article bearing indicia of a sports object, a first icon attached to the article, a second icon attached to the article and spaced from the first icon, and an outcome indicator attached to the article and positioned substantially intermediate to the first and second icons. The first and second icons are attached to the article with the second icon spaced from the first icon and the outcome indicator is intermediate to the first and second icons. The outcome indicator distinguishes between the winning and losing teams by the position of the icons with respect to the outcome indicator. The outcome indicator is configured to display a greater than sign towards an icon associated with a winning team and a less than sign towards an icon associated with a losing team.

The instant invention provides a display apparatus and method for displaying icons representing two teams competing or opposing one another in a sporting event. The claimed invention enables a user to indicate their predicted outcome as to which team will win a game. An alternative, though not necessarily mutually exclusive, use of the display apparatus would be for a user to indicate the desired outcome as to which team will win the game such as may be the case for a dyed in the wool fan of a team that is not fairing especially well. One embodiment of the inventive apparatus includes an article with indicia associated with a sports object such as a football, baseball, basketball, hockey puck and the like. The article further includes an outcome indicator which indicates which of the teams is predicted to win the sporting event by pointing to the icon associated with the winning team. The outcome indicator may be a sign or symbol such as a greater than sign facing the winning team and less than sign facing the losing team, though other symbols and markings may be used.

The inventive apparatus can be affixed to an automobile or other vehicle to display the user's affiliation as well as the predicted or desired outcome of a sporting event. An embodiment features magnetic components, so they will stick to each other as well as to a vehicle or other metal object. Some embodiments of the invention are configured to fit on the front license plate of a vehicle. The icons and team logos may represent college teams, professional teams, local fraternity, sorority, office teams, etc. The icons and team logos are stuck on the sports object shaped base via magnets, hook and loop fasteners, or other methods.

The different components of the Sports Forecaster system can be used in multiple configurations and may include a plurality of articles bearing indicia associated with a sports object. Additionally, the inventive system may include the icons representing several teams, such as each team of a league, conference, or series of games. Other embodiments may include different object shaped bases and team icons. Blank discs may be included for user customization by adding their own icons to the inventive apparatus to predict the outcome between teams of a smaller area such as an intramural softball league.

Different outcome indicators may be used and positioned on the article bearing markings or other indicia of a sports object. Other embodiments of the inventive apparatus and method may include additional accessories to indicate game scores and point spreads. Other embodiments may include articles and icons that are back-lit or made from materials with reflective or luminescent characteristics.

The present invention relates generally to a display apparatus and method and more particularly, to a display apparatus and method for indicating the outcome of a match between two rival parties using an article bearing indicia of a sports object that is associated with the particular sport that the rival parties are competing in. The article bearing indicia of a sports object, also includes an outcome indicator which indicates the winning team and the losing team based on the position of an icon, logo, or other representations of the teams with respect to the outcome indicator.

The icons representing each team are removable and can be replaced with other icons. The user with a preference for the home team, can replace the icon of a prior visiting team with the icon representing the team that will be competing against the home team for an upcoming game. The inventive apparatus is particularly appropriate to show support for a home or preferred team over the opposing team over the course of an entire season.

In accordance with an embodiment of the present invention, a display apparatus is provided featuring an article bearing indicia of a sports object, a first icon attached to the article, a second icon attached to the article and spaced from the first icon, and an outcome indicator attached to the article and positioned substantially intermediate to the first and second icons.

In accordance with yet another embodiment of the present invention, a display apparatus is provided that includes a first disc bearing the logo of a first team, a second disc bearing the logo of a second team, an outcome indicator, and an article bearing indicia of a sports object where the first disc is removably attached to the article at a first location and the second disc is removably attached to the article at a second location and the outcome indicator is attached to the article at third position that is between the first position and the second position.

In accordance with still another aspect of the present invention, a method is provided for indicating a winning team from amongst two opposing teams including the steps of displaying an article having markings associated with a sports object, placing a first icon representative of a first team onto said article at a first location, and placing a second icon representative of a second team onto the article at a second location where the article further comprises an outcome indicator at a third location intermediate to the first and second locations where the outcome indicator configured to show that the icon placed onto the article at the first position is the winning team.

In accordance with still another embodiment of the present invention, a display apparatus is provided which includes a first icon, a second icon, an article having markings of a sports object where the first icon is removably attached to the article at a first location and the second icon is removably attached to the article at a second location and the article further includes an outcome indicator at a location that is substantially intermediate to the first and second locations.

Accordingly, it is an object of the present invention to provide an improved display device. There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE DRAWINGS

Further features of the present invention will become apparent to those skilled in the art to which the present invention relates from reading the following description with reference to the accompanying drawings, in which:

FIG. 1 is a front view illustrating a display apparatus according to an embodiment of the invention with an article bearing indicia of a football.

FIG. 2 is a front view illustrating a display apparatus according to an alternate embodiment of the invention with an article bearing indicia of a basketball.

FIG. 3 is a front view illustrating a display apparatus according to an alternate embodiment of the invention with an article bearing indicia of a baseball.

FIG. 4 is a front view illustrating a display apparatus according to an alternate embodiment of the invention with an article bearing indicia of a hockey puck.

FIG. 5 is a front view illustrating a display apparatus according to an alternate embodiment of the invention with a license plate article bearing indicia of a basketball.

FIG. 6 is a front view illustrating a display apparatus according to an alternate embodiment of the invention with a license plate article bearing indicia of a baseball.

FIG. 7 is a front view illustrating a display apparatus according to an alternate embodiment of the invention with a license plate article bearing indicia of a hockey puck.

FIG. 8 is a perspective view illustrating a display apparatus of the embodiment of the invention of FIG. 1 attached to the side of a vehicle.

FIG. 9 is a perspective view illustrating a display apparatus of the embodiment of the invention of FIG. 2 attached to the side of a vehicle.

FIG. 10 is a perspective view illustrating a display apparatus of the embodiment of the invention of FIG. 3 attached to the side of a vehicle.

FIG. 11 is a front view illustrating a display apparatus according to an different configuration of the invention shown in FIG. 1.

FIG. 12 is a front view illustrating a display apparatus according to an different configuration of the invention as shown in FIG. 2.

FIG. 13 is a front view illustrating a display apparatus according to an alternate embodiment of the invention featuring a permanent icon representing a favorite team on license plate article bearing indicia of a football as mounted on a bumper.

FIG. 14 is a front view illustrating a display apparatus according to an alternate embodiment of the invention featuring a permanent icon representing a favorite team on a license plate article bearing indicia of a basketball as mounted on a bumper.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not been maintained in the Figures. In some cases, the sizes of certain small components have been exaggerated for illustration.

An embodiment in accordance with the present invention provides a display apparatus and method for indicating the outcome of a match between opposing teams. The inventive apparatus features an article bearing indicia associated with a sports object, an outcome indicator, and first and second icons representing opposing teams. The first and second icons are attached to the article with the second icon spaced from the first icon. The outcome indicator is substantially intermediate to the first and second icons. The outcome indicator distinguishes between the winning and losing teams. The claimed invention enables a user to indicate their predicted outcome as to which team will win a game. The outcome indicator may be a symbol such as a greater than symbol though other symbols and markings may be used.

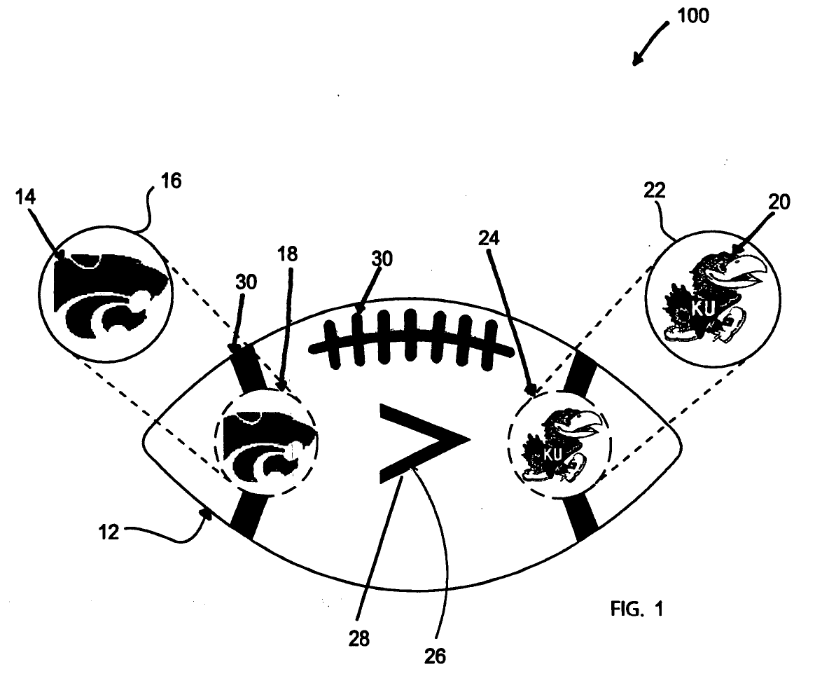

An embodiment of the present inventive apparatus and method is illustrated in FIG. 1, which shows a front view of a display apparatus 100 according to an embodiment of the invention having an article 12 bearing indicia of a football. While the article 12 of FIG. 1 bears indicia of a football, in other embodiments, the article 12 may bear indicia associated with any type of sports objects. Examples of a sports object include a football, baseball, basketball, tennis ball, dodge ball, golf ball, softball, hockey puck, soccer ball, and tennis racket. The indicia associated with the sports object has many forms and may include one or more of the following attributes coloring, markings, patterns, texture, stitching, and shape. It will be appreciated by one of ordinary skill that by bearing one or more of the attributes of a sports object, an article 12 may approximate the appearance of a sports object such as a football even if the actual shape of the article is rectangular.

As depicted in the embodiment of FIG. 1, article 12 is relatively flat and can be mounted to any number of locations including a wall, side of a bus or automobile and the like. One of skill in the art will appreciate that the article does not have to be relatively flat and may be mounted any number of ways including magnetically, or via adhesive backing.

The display apparatus 100 further includes a first icon 14 that is representative of a first team or party which may be mounted on a disc 16 and attached to article 12 at a first location 18. The display apparatus 100 further includes a second icon 20 that is representative of a second team which may be mounted on a disc 22 as shown at attached to article 12 at a second location 24. One skilled in the art will appreciate that icons in fact represent any number of ways to refer to a team or competitor and are not limited to logos and mascots. Besides mascots and logos, other examples of icons include but are not limited to lettering, names, nicknames, colors, trademarks or any way to identify or referring to a team or competitor. In an embodiment, the first icon 14 and second icon 20 are removably attached to the article 12. This may be accomplished using any removable fastening method or device such as a magnetic field, magnetic backings, adhesive backing, or hook and loop fasteners.

The display apparatus 100 further includes an outcome indicator 26 located on article 12 at a third location 28 between or intermediate to the aforementioned first location 18 and second location 24. The outcome indicator 26 indicates the outcome of the game or contest by identifying which the icon of the team that is the winning team. As shown, the outcome indicator 26 is configured to display a greater than sign towards an icon associated with a winning team 14 and a less than sign towards an icon associated with a losing team 20. In identifying the winning team, the remaining team is necessarily the losing team. As shown in FIG. 1, the team identified with the first icon 14 at the first location 18 is the winning team.

Further indicia details of the article 12 as depicted in FIG. 1 include markings 30 such as stripes and stitching as well as a football shape. As previously mentioned other F indicia may include attributes such as coloring, markings, patterns, texture, and the appearance of texture.

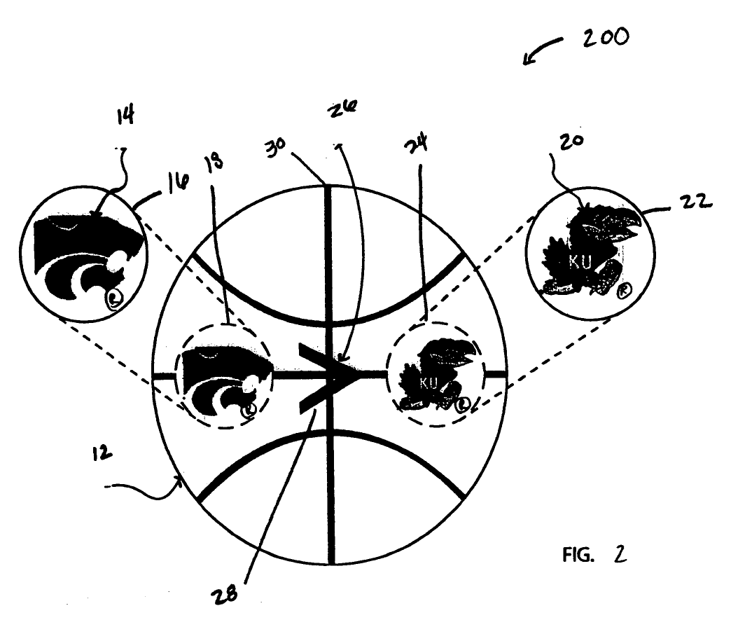

FIG. 2 is a front view illustrating a display apparatus 200 according to an alternate embodiment of the invention with an article 12 bearing indicia of a basketball. As shown, article 12 is relatively flat and capable of being mounted to any number of locations including a wall, side of a bus or automobile and the like. The display apparatus 200 further includes a first icon 14 that is representative of a first team or party which may be mounted on a disc 16 and attached to article 12 at a first location 18. The display apparatus 200 further includes a second icon 20 that is representative of a second team which may be mounted on a disc 22 as shown at attached to article 12 at a second location 24. As shown, the first icon 14 and second icon 20 may be removably attached to the article 12. The display apparatus 200 further includes an outcome indicator 26 located on article 12 at a third location 28 between or intermediate to the aforementioned first location 18 and second location 24. The outcome indicator 26 indicates the outcome of the game or contest by identifying which the icon of the team that is the winning team. In identifying the winning team, the remaining team is necessarily the losing team. As shown in FIG. 2, the team identified with the first icon 14 at the first location 18 is the winning team. Further indicia details of the article 12 as depicted in FIG. 2 include markings 30 such as stripes as well as a basketball shape.

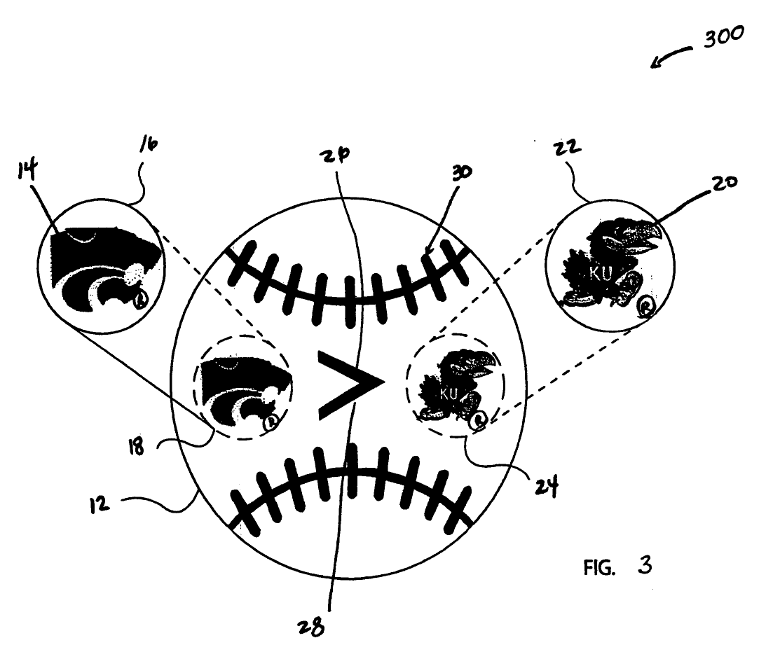

FIG. 3 is a front view illustrating a display apparatus 300 according to an alternate embodiment of the invention with an article 12 bearing indicia of a baseball. As shown, article 12 is relatively flat and capable of being mounted to any number of locations including a wall, side of a bus or automobile and the like. The display apparatus 300 further includes a first icon 14 that is representative of a first team or party which may be mounted on a disc 16 and attached to article 12 at a first location 18. The display apparatus 300 further includes a second icon 20 that is representative of a second team which may be mounted on a disc 22 as shown at attached to article 12 at a second location 24. As shown, the first icon 14 and second icon 20 are removably attached to the article 12. The display apparatus 300 further includes an outcome indicator 26 located on article 12 at a third location 28 between or intermediate to the aforementioned first location 18 and second location 24. The outcome indicator 26 indicates the outcome of the game or contest by identifying which the icon of the team that is the winning team. As shown in FIG. 3, the team identified with the first icon 14 at the first location 18 is the winning team. Further indicia details of the article 12 as depicted in FIG. 3 include markings 30 such as stitching as well as a baseball shape.

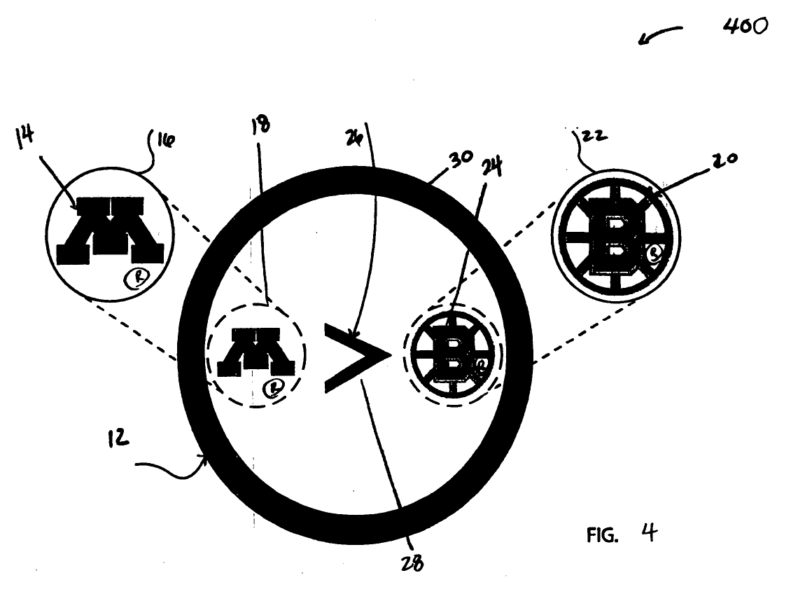

FIG. 4 is a front view illustrating a display apparatus 400 according to an alternate embodiment of the invention with an article 12 bearing indicia of a hockey puck. As shown, article 12 is relatively flat and capable of being mounted to any number of locations including a wall, side of a bus or automobile and the like. The display apparatus 400 further includes a first icon 14 that is representative of a first team or party which may be mounted on a disc 16 and attached to article 12 at a first location 18. The display apparatus 400 further includes a second icon 20 that is representative of a second team which may be mounted on a disc 22 as shown at attached to article 12 at a second location 24. As shown, the first icon 14 and second icon 20 are configured to be removably attached to the article 12. The display apparatus 400 further includes an outcome indicator 26 located on article 12 at a third location 28 between or intermediate to the aforementioned first location 18 and second location 24. The outcome indicator 26 indicates the outcome of the game or contest by identifying which the icon of the team that is the winning team. In identifying the winning team, the remaining team is necessarily the losing team. As shown in FIG. 4, the team identified with the first icon 14 at the first location 18 is the winning team. Further indicia details of the article 12 as depicted in FIG. 4 include markings 30 as well as a hockey puck shape.

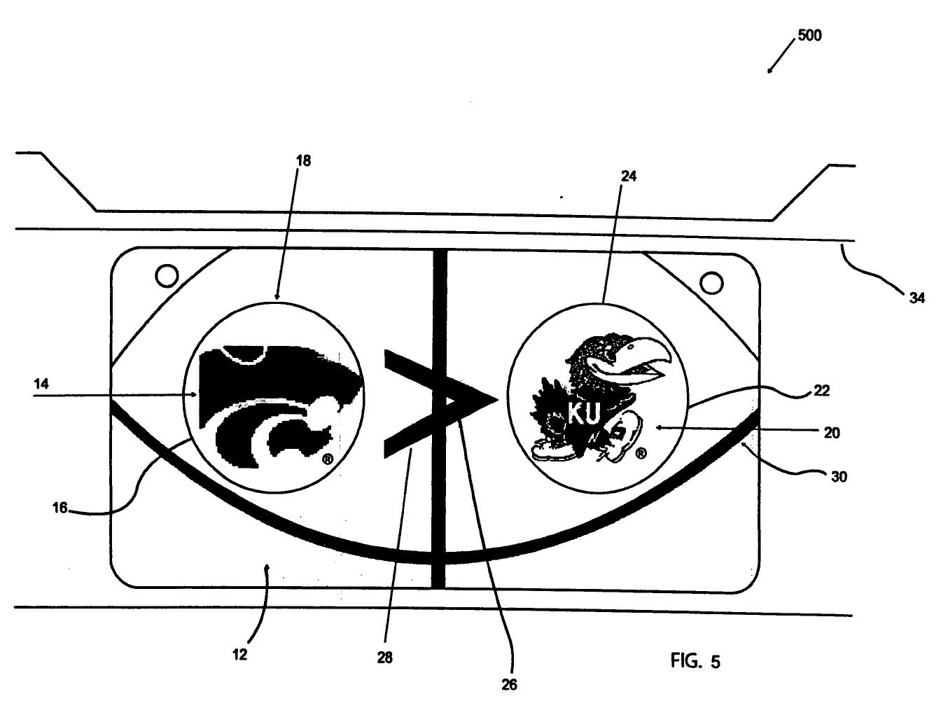

FIG. 5 is a front view illustrating a display apparatus 500 according to an alternate embodiment of the invention with a license plate article 12 bearing indicia of a basketball as mounted on a bumper 34. As shown, article 12 is relatively flat and capable of being mounted on an automobile and the like. The display apparatus 500 further includes a first icon 14 that is representative of a first team or party which may be mounted on a disc 16 and attached to article 12 at a first location 18. The display apparatus 500 further includes a second icon 20 that is representative of a second team which may be mounted on a disc 22 as shown at attached to article 12 at a second location 24. As shown, the first icon 14 and second icon 20 are configured to be removably attached to the article 12. The display apparatus 500 further includes an outcome indicator 26 located on article 12 at a third location 28 between or intermediate to the aforementioned first location 18 and second location 24. The outcome indicator 26 indicates the outcome of the game or contest by identifying which the icon of the team that is the winning team. In identifying the winning team, the remaining team is necessarily the losing team. As shown in FIG. 5, the team identified with the first icon 14 at the first location 18 is the winning team. Further indicia details of the article 12 as depicted in FIG. 5 include markings 30 such as stripes as well as a basketball shape.

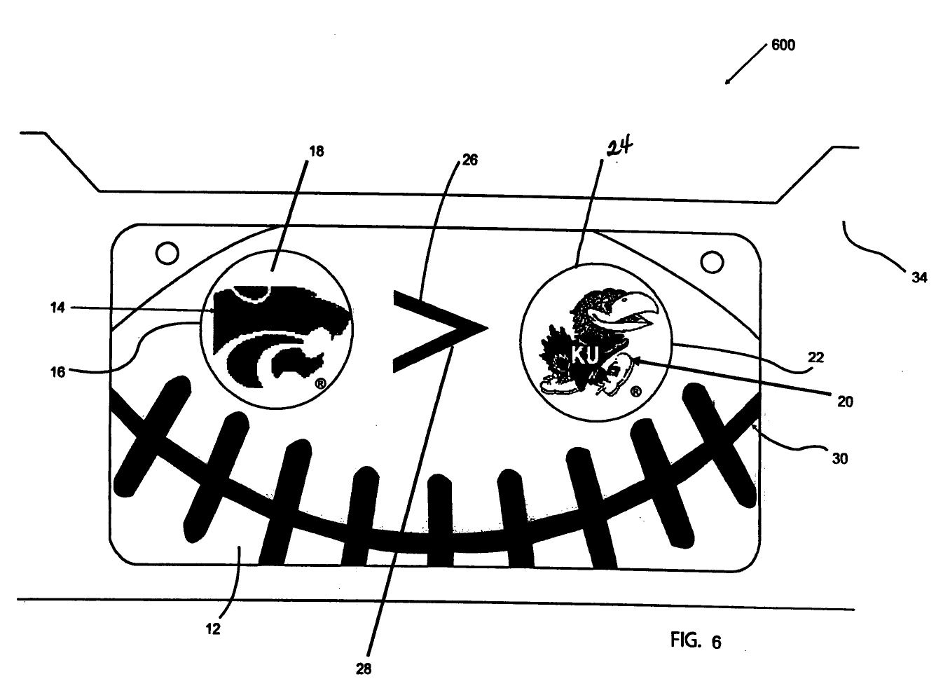

FIG. 6 is a front view illustrating a display apparatus 600 according to an alternate embodiment of the invention with a license plate article 12 bearing indicia of a baseball as mounted on a bumper 34. As shown, article 12 is relatively flat and capable of being mounted on an automobile and the like. The display apparatus 600 further includes a first icon 14 that is representative of a first team or party which may be mounted on a disc 16 and attached to article 12 at a first location 18. The display apparatus 600 further includes a second icon 20 that is representative of a second team which may be mounted on a disc 22 as shown at attached to article 12 at a second location 24. As shown, the first icon 14 and second icon 20 are configured to be removably attached to the article 12. The display apparatus 600 further includes an outcome indicator 26 located on article 12 at a third location 28 between or intermediate to the aforementioned first location 18 and second location 24. The outcome indicator 26 indicates the outcome of the game or contest by identifying which the icon of the team that is the winning team. In identifying the winning team, the remaining team is necessarily the losing team. As shown in FIG. 6, the team identified with the first icon 14 at the first location 18 is the winning team. Further indicia details of the article 12 as depicted in FIG. 6 include markings 30 such as stitching as well as a baseball shape.

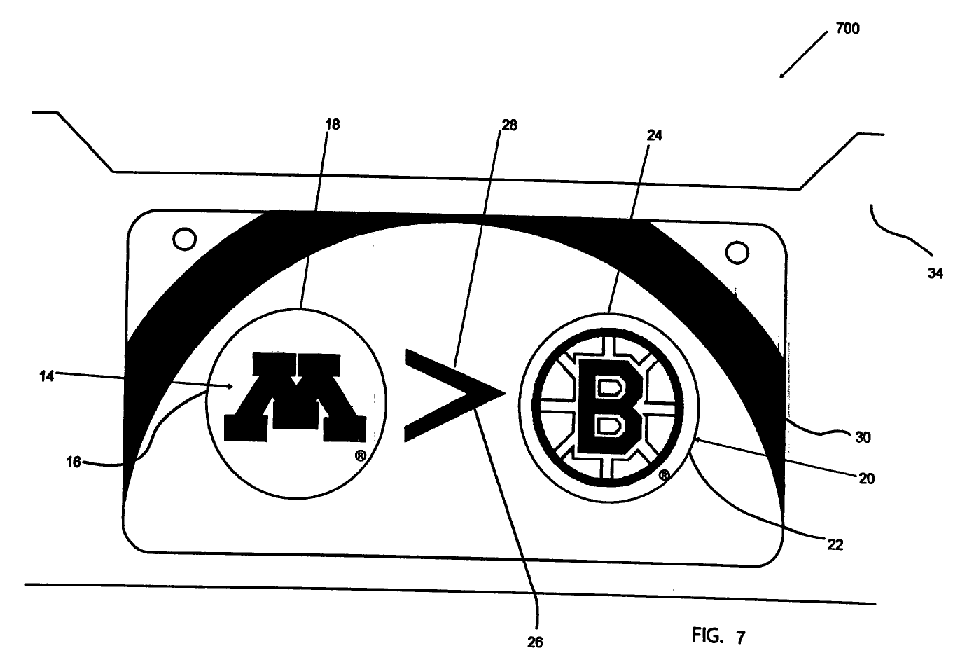

FIG. 7 is a front view illustrating a display apparatus 700 according to an alternate embodiment of the invention with a license plate article 12 bearing indicia of a hockey puck as mounted on a bumper 34. As shown, article 12 is relatively flat and capable of being mounted on an automobile and the like. The display apparatus 700 further includes a first icon 14 that is representative of a first team or party which may be mounted on a disc 16 and attached to article 12 at a first location 18. The display apparatus 700 further includes a second icon 20 that is representative of a second team which may be mounted on a disc 22 as shown at attached to article 12 at a second location 24. As shown, the first icon 14 and second icon 20 are removably attached to the article 12. The display apparatus 700 further includes an outcome indicator 26 located on article 12 at a third location 28 between or intermediate to the aforementioned first location 18 and second location 24. The outcome indicator 26 indicates the outcome of the game or contest by identifying which the icon of the team that is the winning team. In identifying the winning team, the remaining team is necessarily the losing team. As shown in FIG. 7, the team identified with the first icon 14 at the first location 18 is the winning team. Further indicia details of the article 12 as depicted in FIG. 7 include markings 30 as well as a hockey puck shape.

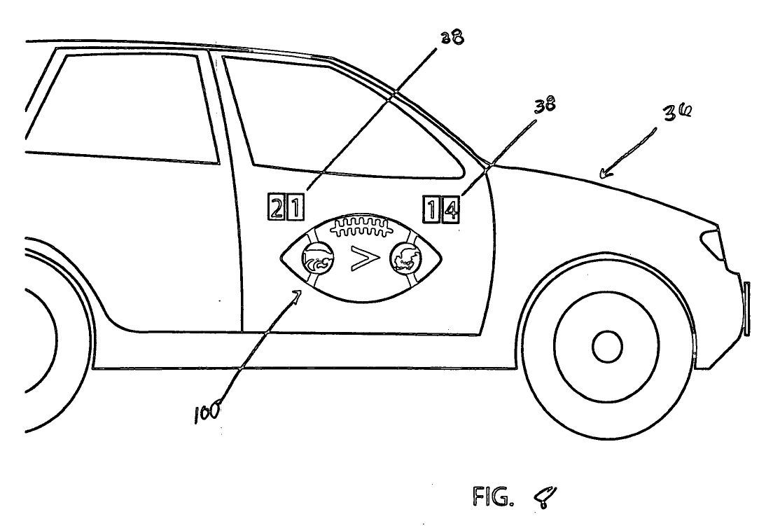

FIG. 8 is a perspective view illustrating a display apparatus 100 of the embodiment of the invention of FIG. 1 attached to the side of a vehicle 36. Also shown are numbers displaying the predicted score 38 for each team.

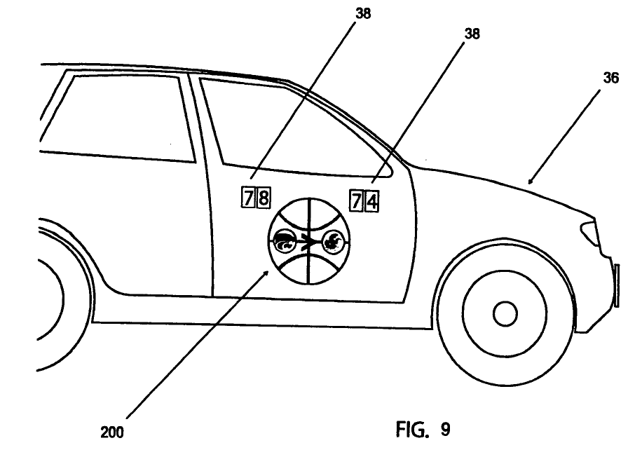

FIG. 9 is a perspective view illustrating a display apparatus 200 of the embodiment of the invention of FIG. 2 attached to the side of a vehicle 36. Also shown are numbers displaying the predicted score 38 for each team.

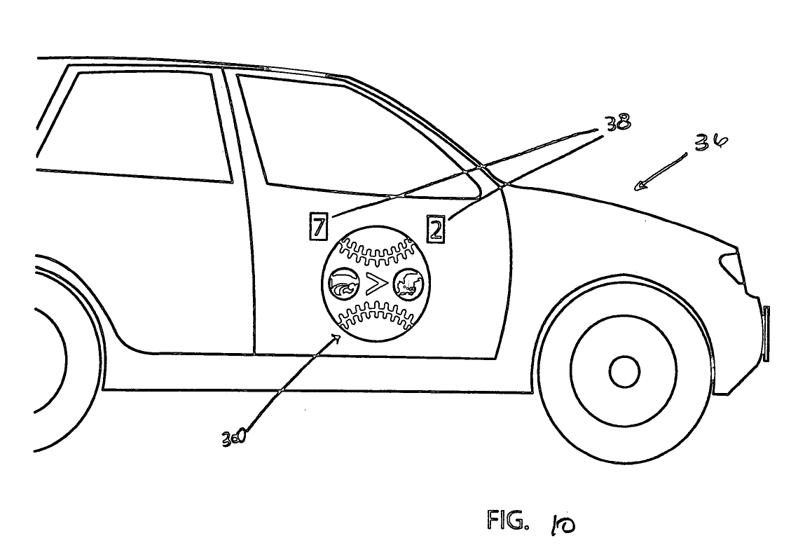

FIG. 10 is a perspective view illustrating a display apparatus 300 of the embodiment of the invention of FIG. 3 attached to the side of a vehicle 36. Also shown are numbers displaying the predicted score 38 for each team.

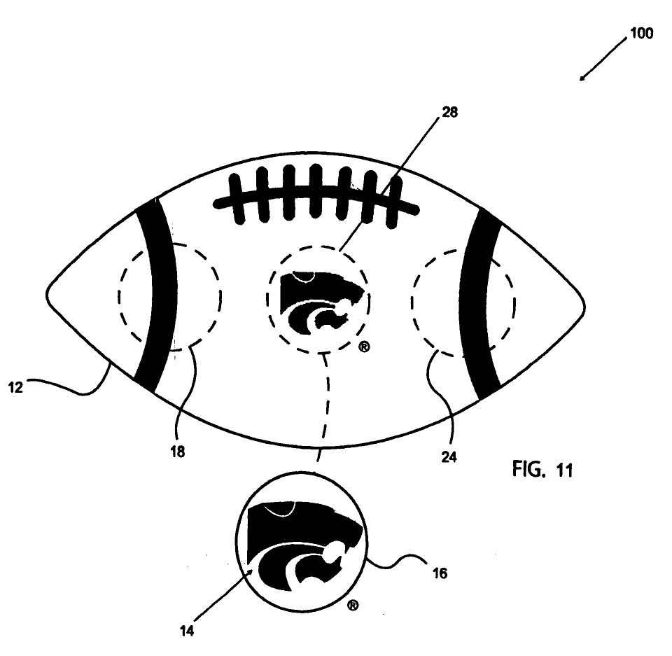

FIG. 11 is a front view illustrating a display apparatus 100 according to an different configuration of the invention shown in FIG. 1. FIG. 11 shows a front view of a display apparatus 100 according to an embodiment of the invention with an article 12 bearing indicia of a football. In the depicted configuration, the first icon 14 and disc 16 are located on the article 12 at the third location 28 between or intermediate to the aforementioned first location 18 and second location 24. This configuration of the instant invention is desirable when there is not an upcoming game or the user simply wishes to display their team affiliation.

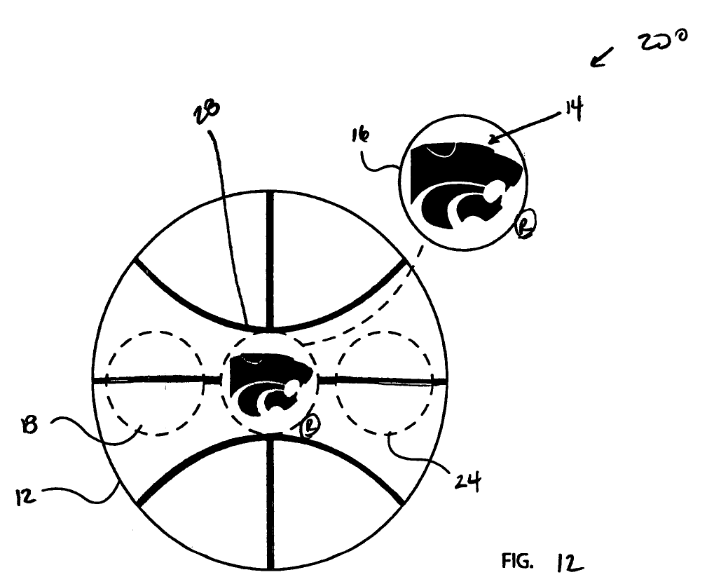

FIG. 12 is a front view illustrating a display apparatus 200 according to an different configuration of the invention as shown in FIG. 2. FIG. 12 shows a front view of a display apparatus 200 according to an embodiment of the invention with an article 12 bearing indicia of a basketball. In the depicted configuration, the first icon 14 and disc 16 are located on the article 12 at the third location 28 between or intermediate to the aforementioned first location 18 and second location 24. This configuration of the instant invention is desirable when there is not an upcoming game or the user simply wishes to display their team affiliation.

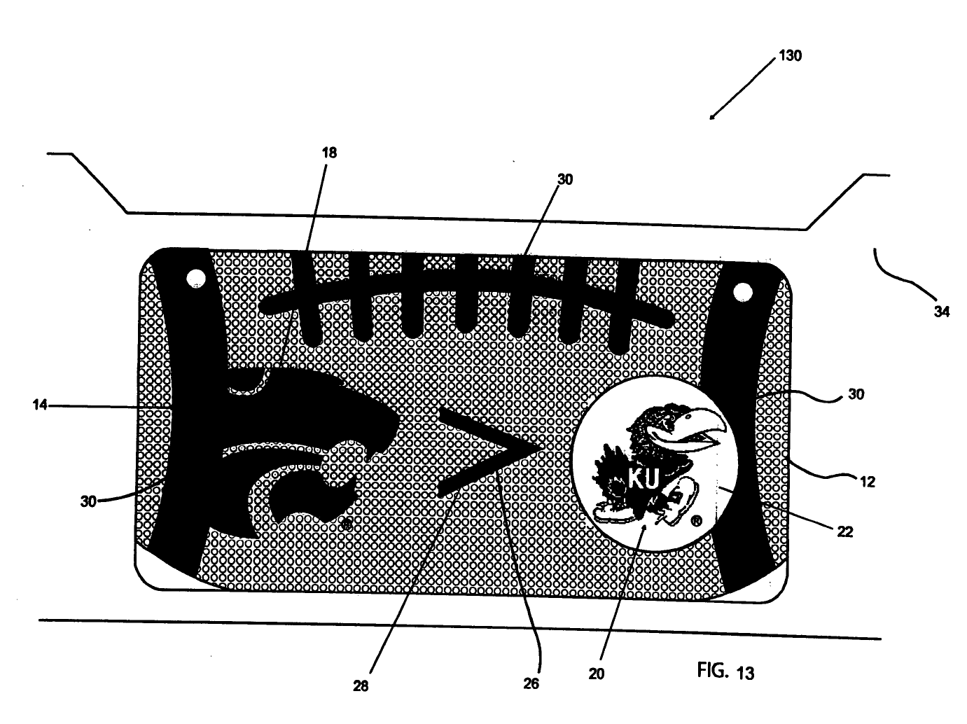

FIG. 13 is a front view illustrating a display apparatus 130 according to an alternate embodiment of the invention featuring a permanent icon 14 representing a favorite team on license plate article 12 bearing indicia of a football as mounted on a bumper 34. As shown, article 12 is preferably relatively flat and capable of being mounted on an automobile and the like. The display apparatus 130 further includes a first icon 14 that is representative of a favorite team or party which is permanently attached or printed on article 12 at a first location 18. The display apparatus 130 further includes a second icon 20 that is representative of a second team which may be mounted on a disc 22 as shown at attached to article 12 at a second location 24. As shown, the second icon 20 is removably attached to the article 12. The display apparatus 130 further includes an outcome indicator 26 located on article 12 at a third location 28 between or intermediate to the aforementioned first location 18 and second location 24. The outcome indicator 26 indicates the outcome of the game or contest by identifying which the icon of the team that is the winning team. In identifying the winning team, the remaining team is necessarily the losing team. As shown in FIG. 13, the team identified with the first icon 14 at the first location 18 is the winning team. Further indicia details of the article 12 as depicted in FIG. 13 include markings 30 such as stripes and stitching as well as a football pattern.

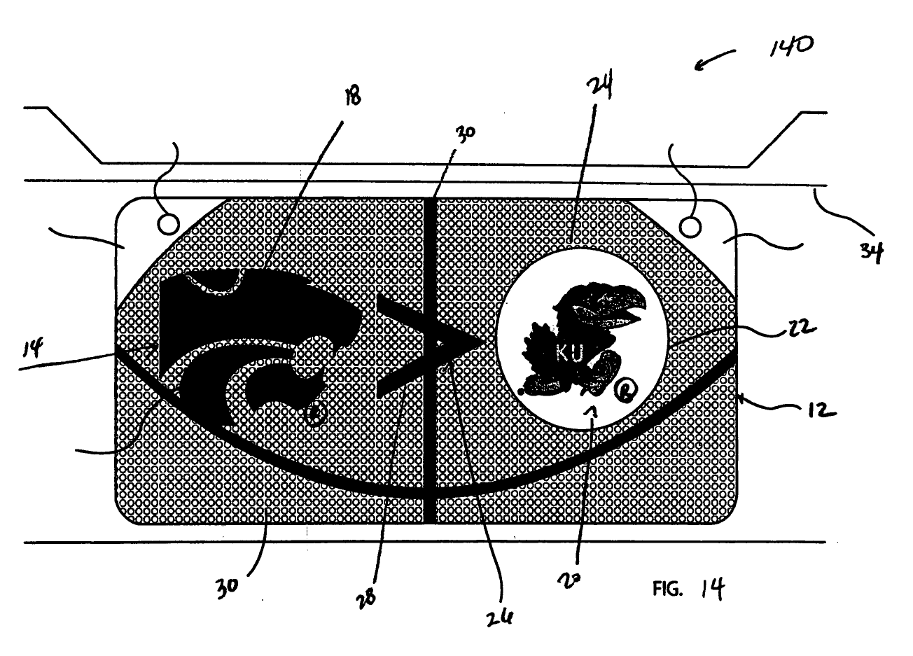

FIG. 14 is a front view illustrating a display apparatus 140 according to an alternate embodiment of the invention featuring a permanent icon 14 representing a favorite team on license plate article 12 bearing indicia of a basketball as mounted on a bumper 34. As shown, article 12 is preferably relatively flat and capable of being mounted on an automobile and the like. The display apparatus 140 further includes a first icon 14 that is representative of a favorite team or party which is permanently attached or printed on article 12 at a first location 18. The display apparatus 140 further includes a second icon 20 that is representative of a second team which may be mounted on a disc 22 as shown at attached to article 12 at a second location 24. As shown, the second icon 20 is removably attached to the article 12. The display apparatus 140 further includes an outcome indicator 26 located on article 12 at a third location 28 between or intermediate to the aforementioned first location 18 and second location 24. The outcome indicator 26 indicates the outcome of the game or contest by identifying which the icon of the team that is the winning team. In identifying the winning team, the remaining team is necessarily the losing team. As shown in FIG. 14, the team identified with the first icon 14 at the first location 18 is the winning team. Further indicia details of the article 12 as depicted in FIG. 14 include markings 30 such as stripes as well as a basketball pattern.

The many features and advantages of the invention are apparent from the detailed specification, and thus, it is intended by the appended claims to cover all such features and advantages of the invention which fall within the spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Having described at least one preferred embodiment of the invention, what is claimed is:

1. A display apparatus comprising:
an article bearing indicia of a sports object;
a first icon attached to said article;
a second icon attached to said article and spaced from said first icon; and
an outcome indicator attached to said article and positioned substantially intermediate to said first and second icons.

2. The display apparatus of claim 1 wherein said outcome indicator is configured to display a greater than sign towards an icon associated with a winning team and a less than sign towards an icon associated with a losing team.

3. The display apparatus of claim 1 wherein said article further comprises a magnetic backing.

4. The display apparatus of claim 1 wherein said first and second icons are removably attached to said article.

5. The display apparatus of claim 1 wherein said first and second icons are removably attached to said article by a magnetic field.

6. The display apparatus of claim 1 wherein said first and second icons are removably attached to said article by hook and loop fasteners.

7. The display apparatus of claim 1 wherein said article is a license plate.

8. The display apparatus of claim 1 wherein said sports object is from the group consisting of: a football, baseball, basketball, tennis ball, dodge ball, golf ball, softball, hockey puck, soccer ball, and tennis racket.

9. The display apparatus of claim 1 further comprising one or more numbers for indicating a game score.

10. A display apparatus comprising:
a first disc bearing the logo of a first team;
a second disc bearing the logo of a second team;
an outcome indicator; and
an article bearing indicia of a sports object wherein said first disc is removably attached to said article at a first location and said second disc is removably attached to said article at a second location and said outcome indicator is attached to said article at third position that is between said first position and said second position.

11. The display apparatus of claim 10 wherein said article further comprises a magnetic backing.

12. The display apparatus of claim 10 wherein said first and second discs are removably attached to said article by a magnetic field.

13. The display apparatus of claim 10 wherein said first and second discs are removably attached to said article by hook and loop fasteners.

14. The display apparatus of claim 10 wherein said article is a license plate.

15. The display apparatus of claim 10 further comprising one or more numbers for indicating a game score.

16. A method indicating a winning team from amongst two opposing teams comprising the steps of:
displaying an article having markings associated with a sports object;
placing a first icon representative of a first team onto said article at a first location; and
placing a second icon representative of a second team onto said article at a second location wherein said article further comprises an outcome indicator at a third location intermediate to said first and second locations where said outcome indicator configured to show that the icon at said first location is the winning team.

17. The method of claim 16 further comprising the step of removing said second icon from said article and placing a third icon representative of a third team onto said article at said second location.

18. A display apparatus comprising:
a first icon;
a second icon; and
an article having markings of a sports object wherein said first icon is removably attached to said article at a first location and said second icon is removably attached to said article at a second location and said article further comprises an outcome indicator at a location that is substantially intermediate to said first and second locations.

19. The display apparatus of claim 18 wherein said article further comprises a magnetic backing.

20. The display apparatus of claim 18 wherein said first and second icons are removably attached to said article by a magnetic field.

21. The display apparatus of claim 18 wherein said article is a license plate.

22. The display apparatus of claim 18 wherein said sports object is from the group consisting of: a football, baseball, basketball, tennis ball, dodge ball, golf ball, softball, hockey puck, soccer ball, and tennis racket.
